(19) United States
(12) Patent Application Publication
(10) Pub. No.: US 2008/0177654 A1
(43) Pub. Date: Jul. 24, 2008

(54) Non-Deterministic Trading Systems and Methods

(76) Inventors: Edmund Hon Wah Hor, Kent (GB); Pranav Bihari, London (GB)

Correspondence Address: GOODWIN PROCTER LLP;PATENT ADMINISTRATOR, EXCHANGE PLACE, BOSTON, MA, 02109-2881, US

(21) Appl. No.: 12/015,796

(22) Filed: Jan. 17, 2008

Related U.S. Application Data
(60) Provisional application No. 60/881,308, filed on Jan. 19, 2007.

(51) Int. Cl. G06Q 40/00

(52) U.S. Cl. 705/37

(57) ABSTRACT

Financial instruments are traded within an electronic marketplace. A proposed trade is received from one market constituent. Trade probabilities representing an estimate that the proposed trade can occur between the party entering the trade and other parties participating in the market are determined. The proposed trades are then presented to other participants in the marketplace, along with (or in some cases coded according to) the trade probabilities.

### CROSS-REFERENCE TO RELATED APPLICATIONS

This application claims priority to U.S. provisional patent application Ser. No. 60/881,308, filed on Jan. 19, 2007, the entire disclosures of which are incorporated herein by reference.

### FIELD OF THE INVENTION

The invention relates generally to increasing the effectiveness and liquidity of markets in which parties trade financial instruments. More specifically, in one embodiment, the invention relates to systems and methods for providing trading parties with improved abilities to trade financial instruments within an electronic marketplace having two or more participants.

### BACKGROUND

Historically, financial instruments such as stocks, bonds, currencies, commodities and their derivatives have been traded at live trading exchanges such as the New York Stock Exchange and the Chicago Mercantile Exchange. Over the past twenty years, however, data processing and communications technology have given rise to electronic trading exchange systems network that utilize communications networks and computers to replace the traditional face-to-face exchanges. Centralized market operators (e.g., exchanges, automated trading systems, brokers, etc.) disseminate market information, maintain records and statistics, settle cash payments, determine risk-based margin requirements, and match orders and trades quickly and efficiently such that all trading activities can be performed electronically.

A communications network connects the exchange computers to numerous trader sites. Each trader site includes one or more trader stations operated by traders. Exchange network operators typically provide exchange members with interface software and, in some cases, hardware to enable traders to view offers, prices and other information relating to products, and to act on that information. This information is often displayed in a grid or other organized format. In many systems, the bids and offers displayed are limited to those that the party can act on and/or which represent the “best tradable price” for that party. Such systems often use credit availability between two parties as a filter for trades. Conventional systems typically use a “credit matrix” to describe values of tradability between counterparties using binary or deterministic values such as “Yes” or “1” representing an actionable trade, and a “No” or a “0” representing a non-actionable trade, as shown in Table 1 below:

TABLE 1
Deterministic Credit Matrix

| | A | B | C | D |
|---|---|---|---|---|
| A | N/A | 0 | 1 | 1 |
| B | 0 | N/A | 1 | 0 |
| C | 1 | 1 | N/A | 1 |
| D | 0 | 0 | 1 | N/A |

The above matrix provides limited information to the trading parties regarding the tradability of an order between them. As shown above, it may not be accurate to depict certain orders as tradable even if credit lines exist between the counterparties. In the same way, certain orders depicted as non-tradable might indeed be tradable via a complex arrangement of several credit-bridging agents. What is needed is a technique and system for using non-deterministic values to describe counterparty relationships and assess tradability within a market.

### SUMMARY OF THE INVENTION

A trading apparatus connects two or more parties in order to facilitate trading of tradable instruments (e.g., financial, commodities, etc.), which may be quoted in a currency or some other form of consideration acceptable to both parties. The trade is conducted through a central computer-based trading system which maintains a trading channel between the two trading parties. Each trading party can enter into the trading system an order that might be a function of financial instrument, price and quantity, among other things. The determination of whether or not a particular order can be traded between the parties is calculated as a probability value by the trading system.

The essential character of a trading system in accordance herewith is that it does not determine that a given order is tradable, but instead communicates a probability value of whether or not a transaction can occur between the trading parties based on a chosen set of parameters that act as inputs to an algorithm. Hence, unlike prior systems that claim to screen orders based on different parameters and provide a tradable order, the present system displays to trading parties orders along with a probability that the orders can be executed given market constraints.

Accordingly, a method for trading financial instruments within an electronic multi-constituent marketplace includes the steps of receiving a proposed trade from one of the market constituents and one or more trade probabilities for the proposed trade. These probabilities represent an estimate that the proposed trade can occur between the party entering the trade and other parties participating in the market. The probabilities can be based on parameters of the trade itself, characteristics of the parties proposing the trade, technical features of the electronic marketplace itself, or other extrinsic parameters that may influence the trade's eventual execution. The proposed trades are then presented to other participants in the marketplace, along with (or in some cases coded according to) the trade probabilities.

The financial instruments may be stocks, equities, corporate bonds, government bonds, commodities, mutual funds, fixed-income investments, exchange-traded funds, futures, currency contracts, and/or any derivatives thereof, and/or any tangible or non-tangible good that may be traded over an electronic network. In addition to the steps outlined above, the method may also include receiving instructions from a party other than the party proposing the trade to execute the trade, and in some cases confirming and/or settling the trade. The proposed trades may also be filtered based on the trade probabilities such that only those proposed trades exceeding a threshold are presented to the other market constituents. The threshold can be defined by the market constituents. In certain implementations, the trade probabilities are calculated. The trade probabilities can vary for any one proposed trade among market participants, over time, as a function of the number of market constituents, or some combination thereof.

In another aspect of the invention, a system for trading financial instruments within an electronic multi-constituent marketplace includes trading client interface software for displaying proposed trades to market participants, a transaction server for calculating trade probabilities for the proposed trade that represent an estimate that the proposed trade can be executed among the market participants and based at least in part on various trade parameters and a distribution server for providing the information regarding the proposed trades and trade probabilities to the trading client interface software.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention

FIG. 1 is an illustration of trading paths among agents with a market according to an embodiment of the invention.

FIG. 2 is a block diagram of a trading platform according to an embodiment of the invention.

### DETAILED DESCRIPTION

The prescribed system attempts to bring more transparency to the view of available orders in the market by showing orders to trading parties that might have been excluded in a prior art system as non-tradable, since certain orders could not be determined to be traded with certainty by such systems.

The invention takes advantage of the fact that there is a certain level of uncertainty inherent in the market, and as such the determination of whether or not a trade could be completed between two trading agents through a computerized trading system cannot always be accurately modeled using a binary representation. Moreover, if the trading system allows credit-bridging agents (i.e., sleeving), the level of uncertainty increases.

The determination of whether or not a particular order can be traded between parties (i.e., participants in one or more markets) is calculated as a probability value based on an algorithm that can take into account several variables, which may be pre-defined system-wide variables, market-specific variables, characteristics of the parties participating in the market in general or directly or indirectly involved in the order, and/or user-defined variables. By considering these variables, the proposed trades can be presented to potential trading parties even though some degree of uncertainty (i.e., a probability <1.0) exists as to whether the trade may actually be executed. Examples of such variables include, but are not limited to:
Mutual credit extended by each trading party as a function of price, quantity or other parameters associated with the proposed trade itself.
Possible paths of credit available through mediating trading parties.
Computation power allocated to the algorithm as a function of time and CPU to find orders having a specified (e.g., minimum) probability of execution.
Statistical data sampling of system stability, network latency, and other technical features of the underlying trading system and the various communication paths over which it transmits data.
Statistical data sampling of the tradability of displayed firm prices, buy-sell behavior, and other parameters associated with the parties proposing to execute a trade.
Users' preferences for relevant variable values, such as not permitting trades for a weather derivative instrument if the forecasted temperature for a period exceeds a specified value at a certain geographical locale.

Consider the following examples. Trading agents A and B trade agricultural futures contracts via a computerized trading system. If A places an order on the trading system for which B has enough credit to trade that order, there is a possibility that while B trades A's order, A withdraws credit extended to B and by the time B's trade reaches the system, the trade can no longer be fulfilled. If there are other trading agents C and D, such that they too have credit to trade A's order, and B, C, and D all trigger an action to trade the order almost simultaneously, only one of the trading agents will be able to trade the order. In this case, factors like network latency may play a role in determining which trade is matched by the system. Hence, it would be inaccurate for a trading system to claim that a certain order is tradable with certainty for a specific trading agent, even in the most simple of trading set-ups. By incorporating these and other non-deterministic factors into a probability that one party will actually be able to act on a particular order, the trading parties have a more accurate view of the market. Furthermore, trades that may have otherwise not been presented to traders (because, for example, no credit existed between the parties or the particular offer is not considered the “best price”) can now be presented to the traders along with an estimate of whether the trade will actually occur if acted upon. Effectively, confirmation of the trade is postponed until the deal actually occurs, as opposed to the pre-deal confirmation generated by many conventional systems. Although this introduces some uncertainty into the market, the market liquidity and transparency is increased such that traders have more options on which to act.

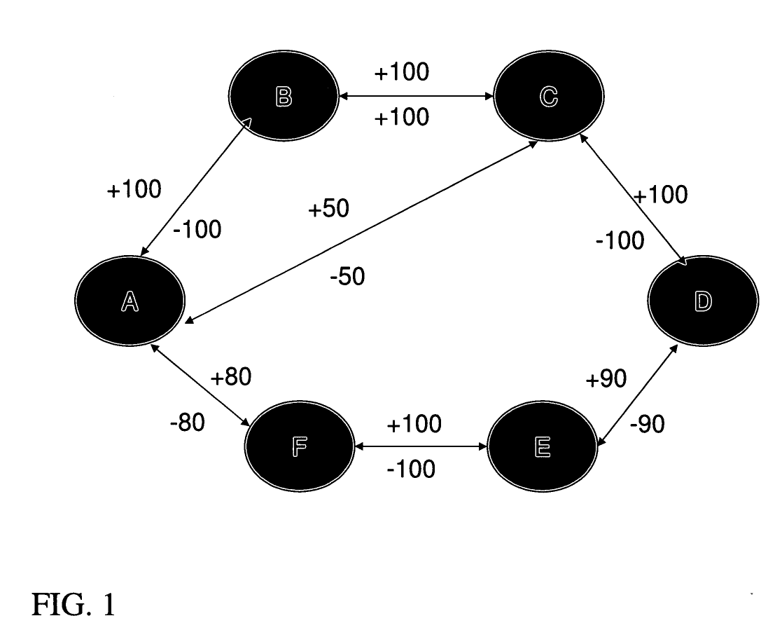

Referring to FIG. 1, in which a number of trading agents trade with each other, certain trading agents may act as credit-bridging agents to facilitate deals between two trading parties, and each of the four trading agents (A, B, C and D) can establish a trading channel with at least one other agent. Agent A wishes to initiate an order as shown in Table 2 below:

TABLE 2
Initial Order

| Agent | Instrument | Quantity | Ask Price |
|---|---|---|---|
| A | Oranges | 15 | $5 |

Lines of credit are defined between each possible pair of trading agents, and are represented by the lines connecting each of the trading agents, with the credit amounts indicated as the numeric numbers annotating each line. In some instances, the credit amounts are mutual (e.g., each party has authorized the same amount of credit with each other) whereas in other cases the credit amounts differ, even between the same two parties. In some circumstances, one party may extend credit to another party, but the other party may or may not reciprocate.

Using the example above, to determine whether agent D can view and/or hit an order from trading party A, the system finds possible “paths” the order can take to be traded between A and D. Because there is no direct line of credit existing between A and D, credit-bridging agents need to be involved. The possible paths in this example for an order with a notional value of $75 could be A→B→C→D or A→F→E→D.

Extending this example to markets having thousands of other agents with trading channels in the system and pre-defined credit lines for each trading pair, the determination of all the possible paths in such a scenario results in having to trade functionality against latency in the system. Therefore, the invention provides an approach for computing the possible paths a trade can take. In some embodiments, the time and processing power allocated to the system may act as a constraint on the process. For example, one parameter may dictate that the system limit the identification of possible paths to those that can be identified within two seconds using a 2 GHz processor. The system can use numerous methods to compute possible paths, including a random walk algorithm, a probabilistic algorithm, a spanning-tree algorithm, a non-deterministic algorithm or any other algorithm used to determine paths through node-based graphs.

Moreover, each path may have associated with it one or more different probabilities of tradability based on parameters such as statistical data sampling of the rate at which B has successfully acted as a credit bridging agent between A and C or the rate at which a specific path A→B→C→D has been a successful route for trades. The probabilities may be calculated based on certain ranges of notional values (e.g., $50-$75, $25-$50, etc.) for an order such that orders within each range may have different probabilities, the type of instrument being traded, the time of day the trade is being offered, as well as other trade parameters. As one example, a foreign exchange trade for Euros at $56 per contract during off-trading hours may have different trade probability than a similar trade at $36 per contract.

Referring again to the order shown in Table 2 and FIG. 1, the probability value presented to trader D by the system can be calculated, for example, as a function of the number of times a deal has been historically successful between A and D for a given notional value range between $50-$75 (e.g., out of 100 attempted trades in this value range, 80 were successful, yielding a probability of 0.8). Because the trade between A and D may incorporate credit-bridging agents B and C, the probability can also be calculated as the number of times the chosen route through B and C has been successful in the past (e.g., out of 100 attempted trades routed along the A→B→C→D path, 70 were successful, yielding a trade probability of 0.7).

In another example, the probability can be based on a network delay. The system determines the average network latency between D and A (by, for example, periodic network pings). If the system determines that the overall latency for a particular path is (or averages) 4 ms, the probability can be based on the number of trades that are executed given such latencies (e.g., out of 100 attempted trades in which the path had a 4 ms latency, 90 were successful, yielding a probability of 0.9). Moreover, the system can combine a set of independent probability values and perform a straight or weighted average calculation to arrive at a composite probability value. The weightings are based on the strength of the relationship between a parameter and the probabilities derived therefrom. As one possible example, if probabilities are computed based on statistics from past trades, the weighting may be based on the number of samples underlying the statistics. For example, if individual trading partner probabilities are considered twice as reliable as the latency probability and the path probability is considered three times as reliable as the latency probability, the weighted average can be calculated as follows:

(2*0.8+3*0.7+1*0.9)/6=0.76.

As an improvement on the prior art systems, the prescribed technique facilitates the pre-screening of orders for tradability using a probability value that incorporates the influence of other possible factors that affect tradability as discussed above. As a result, the counterparty credit matrix of Table 1 above can be modified to incorporate non-deterministic factors and is depicted in Table 3 below:

TABLE 3
Probabilistic Credit Matrix

| | A | B | C | D |
|---|---|---|---|---|
| A | N/A | 0.9 | 0.8 | 0.5 |
| B | 0.8 | N/A | 0.9 | 0.4 |
| C | 0.9 | 0.9 | N/A | 0.9 |
| D | 0.5 | 0.6 | 0.9 | N/A |

In certain instances, there may be no path that links two traders because, for example, Trader A does has not extended credit to trader G and there are no credit-bridging agents to act as intermediaries. Using conventional techniques, such a trade would have no chance of being executed. Using the techniques of the current invention, however, Trader A may indicate that there is a possibility of trade between Trader A and Trader G, if A can confirm the trade once G triggers an action to trade A's order. Trader A may then “extend credit” with a probability value of 0.5 instead of either a fixed amount or 0 (indicating no trade is possible). This credit probability value can depend on several factors internal to A's trading strategy such as overall risk exposure, total volume of the trade, current market conditions, type of instrument, current holdings, etc. Once a non-zero probability has been entered by Trader A, Trader G can see Trader A's order in the system as well as the probability of the deal getting executed by the system. Trader G can deal the order and Trader A can confirm or reject the trade. In conventional systems, by contrast, Trader G cannot view Trader A's order because there is no way to indicate the probability of the trade being successfully executed immediately upon entry of the order.

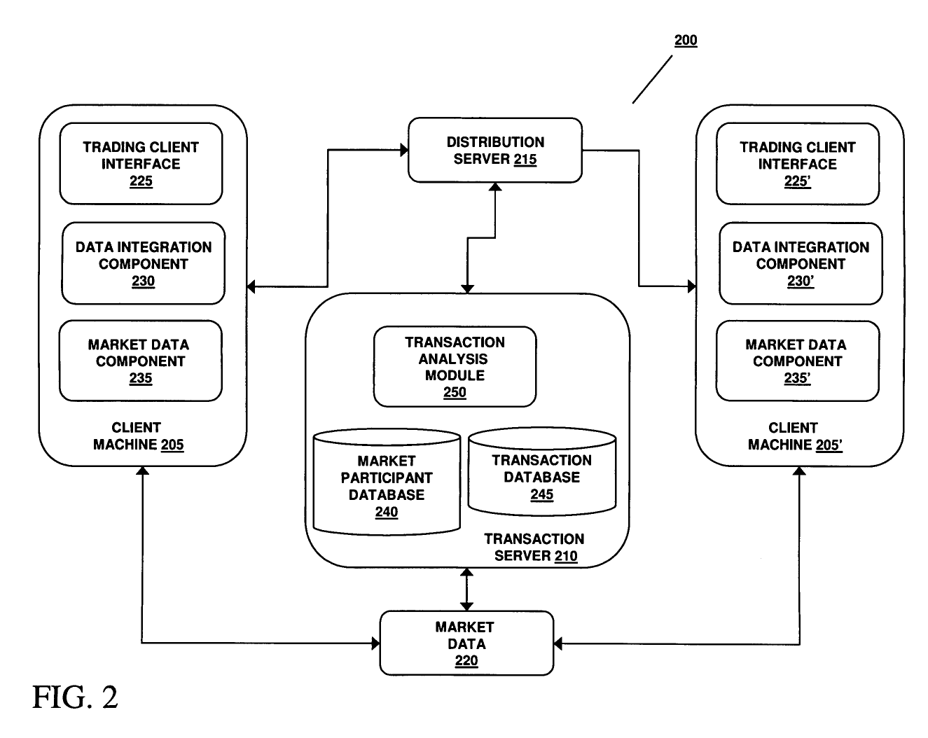

Referring to FIG. 2, one embodiment of a system 200 for implementing the techniques described above includes one or more clients 205, 205′ (generally 205) and at least one server 210. The client 205 is preferably implemented as software running on a personal or professional grade computer workstation (e.g., a PC with an INTEL processor or an APPLE MACINTOSH) capable of running such operating systems as the MICROSOFT WINDOWS family of operating systems from Microsoft Corporation of Redmond, Wash., the MACINTOSH OSX operating system from Apple Computer of Cupertino, Calif., and various varieties of Unix, such as SUN SOLARIS from SUN MICROSYSTEMS, and GNU/Linux from RED HAT, INC. of Durham, N.C. (and others). The client 205 can also be implemented on such hardware as a smart or dumb terminal, network computer, wireless device, personal data assistant, information appliance, workstation, minicomputer, mainframe computer, or other computing device, that is operated as a general purpose computer or a special purpose hardware device solely used for serving as a client 205 in the trading system 200.

The system 200 may also include a distribution server 215 for routing trades and other market transactions between and among the clients 205 and the server 210, as well as a market data server 220 for providing external market data (e.g., foreign exchange rates, public market quotations, news feeds, etc.) to the server 210, the clients 205 or both.

In some embodiments, the client 205 also includes trading client interface software 225. The client software 225 provides functionality to the client 205 that allows a trader to participate in one or more markets. The client software 225 may be implemented in various forms, for example, it may be in the form of a Java applet that is downloaded to the client 205 and runs in conjunction with a web browser, or the client software 225 may be in the form of a standalone application, implemented in a language such as Java, C++, C#, VisualBasic or in native processor executable code. In one embodiment, if executing on the client 205, the client software 225 opens a network connection to the servers 205, 215 and 220 over a communications network and communicates via that connection to the servers.

A communications network connects the clients 205 with the servers 210, 215 and 220. The communication may take place via any media such as standard telephone lines, LAN or WAN links (e.g., T1, T3, 56 kb, X.25), broadband connections (ISDN, Frame Relay, ATM), wireless links, and so on. Preferably, the network can carry TCP/IP protocol communications, and HTTP/HTTPS requests made by the client software 225 and the connection between the client software 225 and the servers 210, 215 and 220 can be communicated over such TCP/IP networks. The type of network is not a limitation, however, and any suitable network may be used. Typical examples of networks that can serve as the communications network include a wireless or wired Ethernet-based intranet, a local or wide-area network (LAN or WAN), and/or the global communications network known as the Internet, which may accommodate many different communications media and protocols.

In some embodiments, the client 205 may also include data integration components to exchange data among each other, the servers and/or external data sources. For example, a data integration component 230 may be used to communicate with the distribution server 215 via an XML-based API using web services. Similarly, a market data component 235 may be implemented for integrating with external data sources such as Bloomberg, Reuters, and other market data providers.

The transaction server 210 provides the application processing component for implementing the techniques for displaying, routing and processing trades as described above. The transaction server 210 may be implemented on one or more server class computers that have sufficient memory, data storage, and processing power and that run a server class operating system (e.g. SUN Solaris, GNU/Linux, MICROSOFT WINDOWS 2000, and later versions, or other such operating system). Other types of system hardware and software than that described here could also be used, depending on the capacity of the device and the number of users and the amount of data received. For example, the transaction server 210 may be part of a server farm or server network, which is a logical group of one or more servers. As another example, there could be multiple servers 210 that may be associated or connected with each other, or multiple servers could operate independently, but with shared data. As is typical in large-scale systems, application software could be implemented in components, with different components running on different server computers, on the same server, or some combination.

The transaction server 210 includes one or more databases, which store data related to the market participants (240) and transactions (245). For instance, the market participant database 240 may store information relating to users of the system, relationships among the users, market statistics, financial instrument definitions, credit rules among market participants, server availability, and network traffic information. The transaction database 245 may contain data regarding individual transactions, whether they be completed, pending, or open. The databases 240, 245 provide data to the transaction server 210. An example of such a database that may be used to implement this functionality include the MySQL Database Server by MySQL AB of Uppsala, Sweden, the PostgreSQL Database Server by the PostgreSQL Global Development Group of Berkeley, Calif., and the ORACLE Database Server offered by ORACLE Corp. of Redwood Shores, Calif.

A transaction analysis module that includes application instructions for calculating the various trading probabilities described above based on, for example, data provided by the databases 240 and 245, as well as data gathered from external sources and network monitoring devices (not shown). The transaction analysis model may, in some embodiments be implemented on the transaction server 210.

The modules described throughout the specification can be implemented in whole or in part as a software program using any suitable programming language or languages (C⁺⁺, C^{#}, java, Visual Basic, LISP, BASIC, PERL, etc.) and/or as a hardware device (e.g., ASIC, FPGA, processor, memory, storage and the like).

The invention can be embodied in other specific forms without departing from the spirit or essential characteristics thereof. The foregoing embodiments are therefore to be considered in all respects illustrative rather than limiting on the invention described herein.

What is claimed is:

1. A method for trading financial instruments within an electronic marketplace, the method comprising:
receiving a proposed trade from a first market constituent;
receiving trade probabilities for the proposed trade, the trade probabilities representing an estimate that the proposed trade can be executed between the first market constituent and a second market participant and based, at least in part, on one or more trade parameters; and
presenting the proposed trade and the respective trade probability to the second market participant.

2. The method of claim 1 wherein the financial instrument is one or more of stocks, equities, corporate bonds, government bonds, commodities, mutual funds, fixed-income investments, exchange traded funds, futures, currency contracts, and any derivatives thereof.

3. The method of claim 1 further comprising receiving instructions from the second market constituent to execute the proposed trade.

4. The method of claim 3 further comprising confirming the trade upon receiving the instructions to execute the proposed trade.

5. The method of claim 1 further comprising filtering the proposed trades based on the trade probabilities and presenting only those proposed trades that exceed a trade probability threshold.

6. The method of claim 5 wherein the trade probability threshold is defined by the second market constituent.

7. The method of claim 1 further comprising calculating the trade probabilities.

8. The method of claim 1 wherein the trade probabilities are further based, at least in part, on technical features of the electronic marketplace.

9. The method of claim 1 wherein the trade probabilities are further based, at least in part, on one or more characteristics of the first market constituent.

10. The method of claim 7 wherein the trade probabilities are further based, at least in part, on one or more characteristics of the second market constituent.

11. The method of claim 1 wherein the trade probabilities vary among market constituents.

12. The method of claim 1 wherein the trade probabilities vary as a function of time.

13. The method of claim 1 wherein the trade probabilities vary as a function of the number of market constituents.

14. The method of claim 1 wherein the trade probabilities are further bases, at least in part, on a historical record of previously proposed trades.

15. A system for trading financial instruments within an electronic multi-constituent marketplace, the system comprising:
a plurality of trading client machines, each machine comprising trading client interface software for displaying proposed trades to market participants;
a transaction server for calculating trade probabilities for the proposed trade, the trade probabilities representing an estimate that the proposed trade can be executed among the market participants and based, at least in part, on one or more trade parameters; and
a distribution server for providing information regarding the proposed trades and trade probabilities to the trading client machines.
